(19) United States
(12) Patent Application Publication
(10) Pub. No.: US 2022/0298832 A1
(43) Pub. Date: Sep. 22, 2022

(54) VEHICLE DOOR HANDLE WITH ELECTRONIC COMPONENT

(71) Applicant: Huf Hülsbeck & Fürst GmbH & Co. KG, Velbert (DE)

(72) Inventors: Heiko Schütz, Velbert (DE); Stefan Mönig, Schwelm (DE)

(73) Assignee: Huf Hülsbeck & Fürst GmbH & Co. KG, Velbert (DE)

(21) Appl. No.: 17/286,752

(22) PCT Filed: Aug. 24, 2020
(86) PCT No.: PCT/EP2020/073617

§ 371 Date: Apr. 19, 2021

(30) Foreign Application Priority Data
Dec. 5, 2019 (DE) 10 2019 133 247.8

(51) Int. Cl. E05B 77/34; E05B 85/16

(52) U.S. Cl. CPC E05B 77/34; E05B 85/16

(57) ABSTRACT

A vehicle door handle is formed with a multi-part housing, with at least one cavity for receiving an electronic component being formed in a first housing part. An insert part for the first housing part has holding elements for holding the electronic component and the insert part is fitted in its shape into a portion of the cavity of the first housing part in such a way that, together with the first housing part, it delimits a portion of the cavity of the first housing part so that a potting trough is formed for receiving a potting agent. This formed potting trough has a base which is formed partly from the insert part and partly by the first housing part. The holding elements for holding the electronic component are placed inside the formed potting trough.

The invention relates to a vehicle door handle for a motor vehicle, with at least one electronic component being received in the vehicle door handle. In particular, the invention relates to a vehicle door handle comprising a multi-part housing, with at least one cavity for receiving the at least one electronic component being formed in a first housing part.

In addition to the mechanical handle function for door or panel movement, vehicle door handles increasingly also fulfill sensory functions or communication functions. For this purpose, electronics in the form of circuit boards with components arranged thereon, including antennas and cables, are received in the motor vehicle door handle.

Motor vehicle door handles of the type mentioned at the outset are usually constructed in multiple parts or with multiple shells, with a first part receiving the essential components of the door handle and being guided through a door panel with protruding lugs, and then, in the assembly process, a cover of the door handle covering the open spaces of the first part and protecting them against environmental influences. Since the door handle is exposed to external influences such as the weather at all times, electronic components in the door handle are usually encased by protective potting compounds. To this end, electronic components are placed in the handle and covered with a suitable electrically insulating potting compound. After this potting compound has cured, the effects of the weather or any liquids that may enter cannot reach the electronic components and have a negative effect on them.

However, there is still a desire to make the door handles as compact as possible and also to make them as light as possible.

The object of the invention is to provide an improved design of vehicle door handles with electronic components which are weight-optimized and compact.

This object is achieved by a vehicle door handle having the features of claim 1.

The vehicle door handle according to the invention is characterized in that, in the multi-part housing of the vehicle door handle, a further part is designed as an insert part for a first housing part. This insert part has holding means for holding the at least one electronic component. The holding means can be designed in many ways, for example as clips, latching lugs, adhesive surfaces or other receptacles, so that the at least one electronic component, e.g. a circuit board with electronic components, can be coupled to the insert part so as to be fixed in position.

The insert part is fitted in its shape into a portion of the cavity of the first housing part in such a way that the insert part together with the first housing part delimits a portion of the cavity of the first housing part. This means that, when the insert part is placed in the intended position within the first housing part, a space is delimited and enclosed which is delimited partly by the housing part itself and partly by the insert part. This is done in such a way that both of the aforementioned components form a potting trough that can receive a potting agent. This potting trough is formed from the insert part and the first housing part and has a base which is formed partly from the insert part and partly by the first housing part.

The insert part is therefore not in itself a potting trough that is inserted into the housing part, but only forms the potting trough together with the housing part when it is inserted therein. This ensures that the trough is formed in the housing part in such a way that the insert part only builds up material and wall thickness where this is necessary to delimit the desired potting space. In the remaining areas, the outer boundary is formed by the first housing part, which makes the installation space more usable. Accordingly, the potting trough consists partly of a housing part and partly of an insert part. The result is a gain in space, in particular in a direction perpendicular to the base surface of the potting trough.

The holding means provided in the insert part for holding the at least one electronic component are placed inside the formed potting trough and are used to establish the location of the at least one electronic component within the potting trough. This ensures that the at least one electronic component is placed in a reproducible position within the vehicle door handle, since on the one hand the insert part is placed in a reproducible position in the first housing part, and on the other hand the electronic component is fastened to the insert part in a defined position.

By forming the potting trough, in particular by forming a portion of the base of the potting trough by the insert part, it is possible to limit the volume of the potting trough to the minimum space required, thereby saving potting compound and weight. While the first handle part has cavities due to the production process, which are not required for receiving the electronic components, but are in continuous fluid connection with the region to be filled, in conventional vehicle door handles it is often possible to enclose all the electronic components with potting compound only by filling the respective underlying regions. This is disadvantageous for both the use of material and the weight of the vehicle door handle. The formation of a potting trough by an insert part on the one hand and a housing part on the other hand ensures that material and weight are really used only where they are necessary. According to the invention, the insert part can be formed in many ways, in particular with a plurality of lateral walls and an open-top design, with the base being partially missing and, when inserted in the first housing part, the missing base being closed by the housing to form the trough. However, it is also possible that the insert part has only portions of lateral walls, in particular in order to form holders for the at least one electronic component.

In a preferred embodiment of the invention, however, the insert is designed partly in a trough-like manner with lateral trough walls and an insert-part trough base connected thereto, the insert-part trough base having at least one recess which, when the insert and the first housing part are connected, is closed by the first housing part so that the potting trough is formed.

This design of the invention ensures that a largely impermeable insert part structure can be placed in the first housing part, so that lateral impermeability is ensured at all times. The insert part only needs to be adjusted in the open base region to achieve the impermeability with respect to the first housing part, and so production with larger tolerances is also possible here.

In a development of the invention, holding means for fixing the position of the insert part in the first housing part are formed between the insert part and the first housing part.

While the insert part can be inserted into the first housing part by means of a press fit, as an alternative, holding means, in particular clips or latching means, offer a particularly reliable and production-tolerant possibility of fixing the insert part in the first housing part.

In a preferred embodiment of the invention, the insert part is placed over a cavity in the first housing part so that said cavity is closed off by the insert part with respect to the potting agent introduced into the potting trough.

In this embodiment, the insert part delimits the potting trough on the one hand and also a cavity in the first housing part which is to be excluded from the potting. In this way, a simple production of the first housing part using the usual production methods is possible, which methods inevitably lead to cavities without an increase in weight due to mandatory filling of the formed cavities.

In a preferred embodiment of the invention, the holding means on the insert part are at least partially designed as strips under which the at least one electronic component can be inserted in an insert part so that the electronic component is prevented from swinging onto a potting agent introduced into the potting trough.

The strip(s) can extend from one side to the other side of the insert part, in particular in the region of the upper boundary, so that the at least one electronic component, for example in the form of a circuit board, is guided obliquely under this strip and is then brought into its final position below the strip. If potting compound is then poured into the formed potting trough, the electronic component is prevented from rising or floating up by the strips, which keep the electronic component below the desired potting level and thus ensure complete encasing of the electronic component.

In a development of the invention, the insert part is formed partly with a soft material which is arranged on the insert part in such a way that it seals the transition between the insert part and the first housing part in the base of the formed potting trough.

According to this embodiment, the insert is overmolded with soft material, for example in portions, or provided with soft material in the form of sealing lips which seal the transition regions between the insert part and the first housing part so that the poured-in potting material is prevented from escaping if complete impermeability between the insert part and the housing part cannot be achieved by other means due to the choice of material or manufacturing tolerances.

The invention will now be explained in more detail with reference to the accompanying drawings.

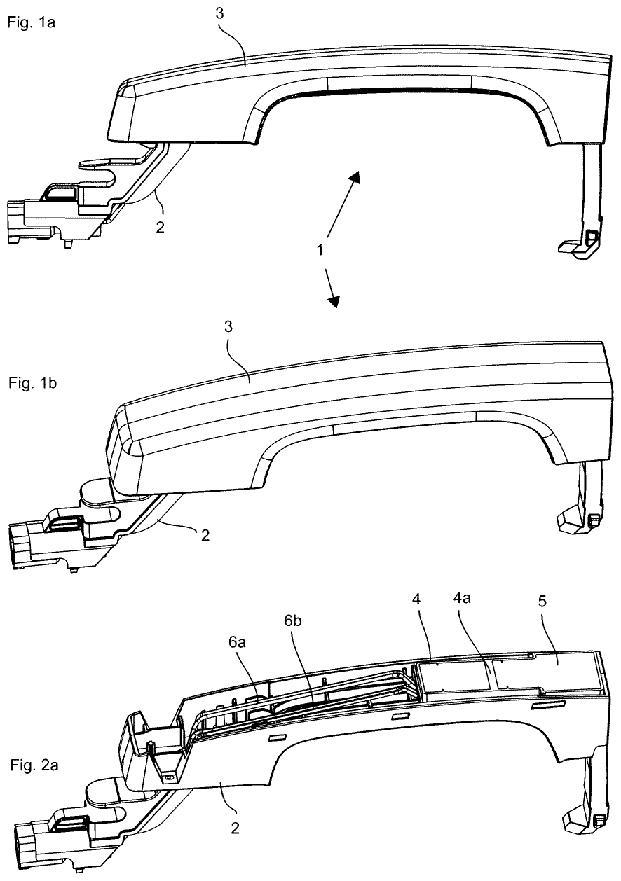

FIG. 1 a shows a vehicle door handle according to a first embodiment of the invention in a side view;

FIG. 1b shows the vehicle door handle from FIG. 1a in an oblique view;

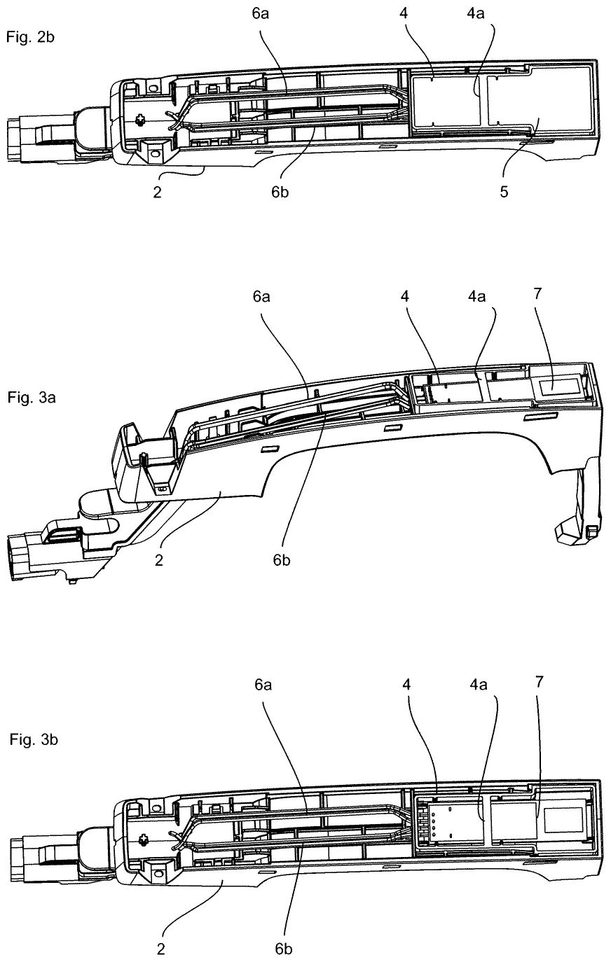

FIG. 2a shows the vehicle door handle according to the first embodiment, with a cover removed;

FIG. 2b shows the arrangement from FIG. 2a in a plan view;

FIG. 3a shows the vehicle door handle according to the first embodiment, without a cover and without potting material in the potting trough;

FIG. 3b shows the arrangement from FIG. 3a in a top view;

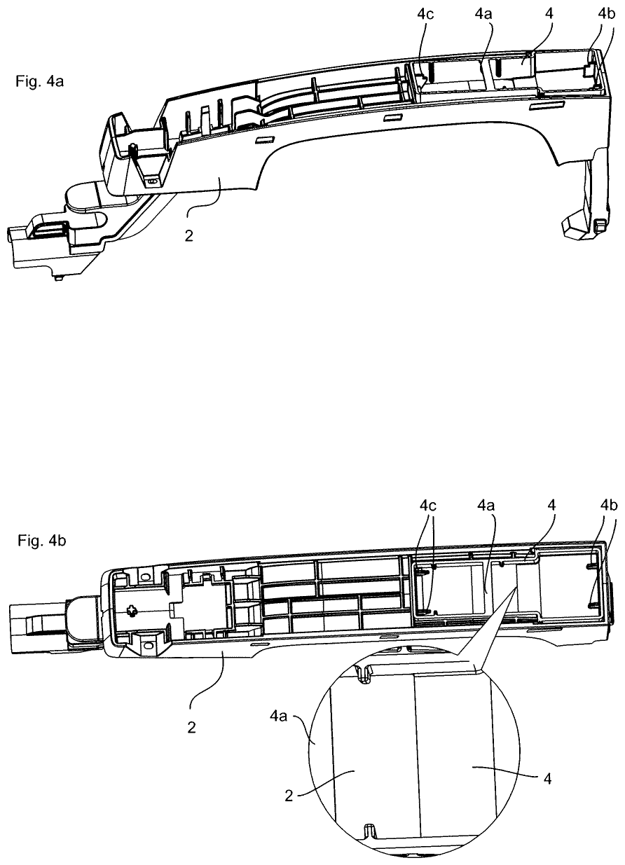

FIG. 4a shows the first handle part of the first embodiment with the insert part inserted;

FIG. 4b shows the arrangement from FIG. 4a in an oblique view;

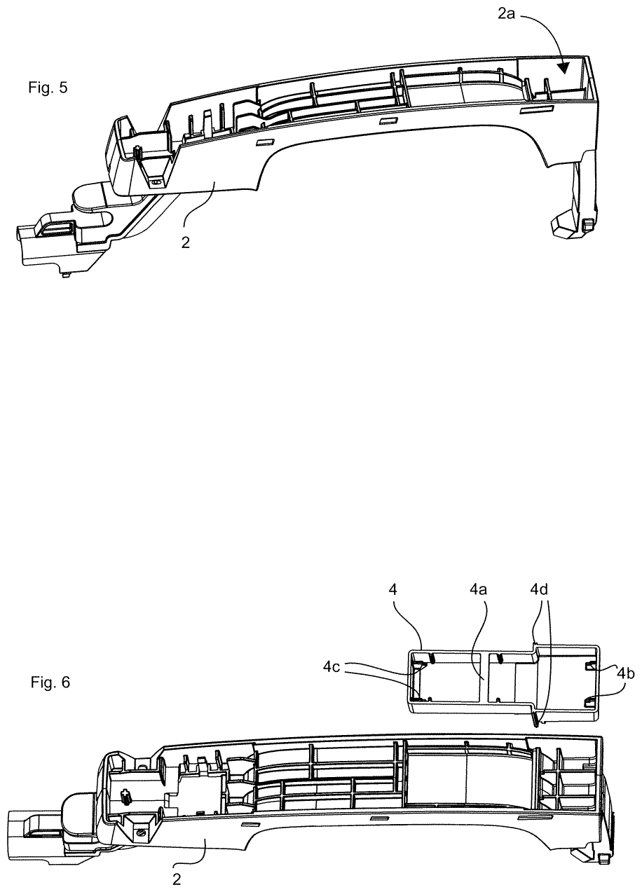

FIG. 5 shows the first housing part of the vehicle door handle according to the first embodiment;

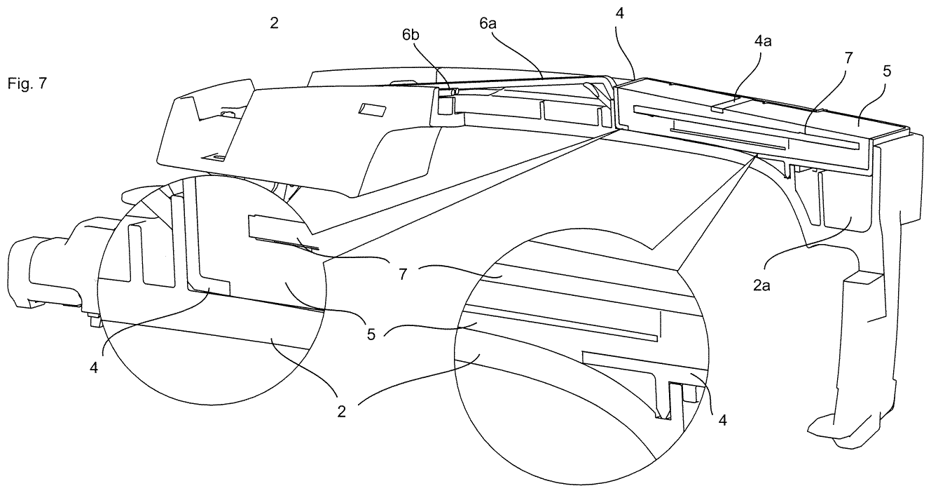

FIG. 6 shows the first housing part and the insert part of the vehicle door handle according to the first embodiment in a further view;

FIG. 7 is a partial sectional view of the vehicle door handle according to the first embodiment without a cover;

A vehicle door handle 1 is shown in FIGS. 1a and 1b. The vehicle door handle 1 has a first housing part 2 which is coupled to a cover 3. A cavity in which components can be received is formed between the cover 3 and the first housing part 2.

In FIG. 2a, the cover 3 has been removed from the housing part 2 so that the interior of the first housing part 2 can be viewed. An insert part 4 is located in the first housing part 2. This insert part 4 forms a potting trough together with the first housing part 2, as will be explained in more detail below. A potting material 5 is poured into the potting trough. Electronic components are embedded in the potting material 5, of which only the supply lines 6a and 6b are visible in this view, since the remaining electronic components are covered by the potting compound 5. A strip 4a spans the insert part 4 and prevents the electronic components from floating on the potting material 5.

On its side facing the vehicle, the first housing part 2 has mechanical coupling means, which, however, need not be explained further in the context of this invention and are also known from the prior art.

FIG. 2b shows the component parts from FIG. 2a in a top view.

FIGS. 3a and 3b show numerous components that have already been shown in FIGS. 2a and 2b, but here the potting compound 5 is hidden. It can thus be seen that a circuit board 7 is located in the insert part 4 as an electronic component and is received there. The supply lines 6a and 6b are galvanically coupled to the components on the circuit board 7. The electronic components on the circuit board 7 can in particular contain antenna arrangements, capacitive sensors or other control and sensing means.

In FIGS. 4a and 4b, the vehicle door handle is shown with an inserted insert part 4, which is fitted into the first housing part 2. The detailed enlargement in FIG. 4b also shows the transition from the insert part 4 to the wall material of the housing part 2. It can be clearly seen here that the base of the potting trough, which is formed in the side frame of the insert part 4, is formed partly from the first housing part 2 and partly from the insert part 4. Below the insert part 4, in the right end portion of the first housing part 2 shown in FIGS. 4a and 4b, a cavity 2a is formed which is covered by the insert part 4 to prevent the potting compound 5 from penetrating into the underlying cavity 2a, thus saving material and making the handle lighter.

In addition, it can be seen in FIGS. 4a and 4b that supports 4b, 4c on which the circuit board 7 can be placed are formed as holding means in the insert part 4. The potting trough formed from the insert part 4 and the first housing part 2 is designed to be impermeable with respect to filling only when the insert part 4 is placed in the housing part 2 so that a closed base of a potting trough is formed.

FIG. 5 shows the first housing part 2 in a perspective view without the insert part 4 received therein. It can be seen there that there is a cavity 2a in the right end portion of the first housing part 2, which cavity is covered by the insert part 4 to form an intermediate base.

In FIG. 6, the first housing part 2 and the insert part 4 are shown side by side. It is clear that squeezing ribs 4d are formed on the insert part 4 which, when the insert part 4 is inserted into the first housing part 2, allow the first insert part 4 to be held firmly in the first housing part 2. In addition, it becomes clear here that the first insert part 4 is designed partly without a base surface; a base surface is only formed in the right end portion in order to cover the cavity in the first housing part 2 with an intermediate base and to form the potting trough.

FIG. 7 is a partial sectional view of the vehicle door handle. This view shows that the merely partial formation of the base of the potting trough by the insert part 4 allows for improved use of the potting space. In the portion of the potting trough in which the base is formed by the first housing part 2, the electronic component 7 can be sunk further into the potting trough due to the lack of base wall. If the insert part 4 had a continuous base surface, less installation space would be available in terms of height for the arrangement of the electronic components.

At the same time, the insert part 4 prevents the cavity 2a from being filled with potting material 5, which would lead to the vehicle door handle being weighed down and to unnecessary material consumption. It can also be seen that, in this embodiment, the lateral boundaries of the insert part 4 protrude beyond the lateral boundaries of the first housing component 2. This makes it possible to realize an optimized overall height design while maintaining the contour of the vehicle door handle and at the same time optimizing the consumption of potting material 5.

1. Vehicle door handle comprising a multi-part housing, with at least one first cavity for receiving at least one electronic component being formed in at least one first housing part,
wherein
an insert part is formed for the first housing part and has holding means for holding the at least one electronic component,
wherein the insert part is fitted in its shape into a portion of the cavity of the first housing part in such a way that the insert part together with the first housing part delimits a portion of the cavity of the first housing part so that a potting trough for receiving a potting agent is formed in the delimited region, the formed potting trough having a base which is formed partly from the insert part and partly by the first housing part and the holding means for holding the at least one electronic component being placed inside the formed potting trough.

2. Vehicle door handle according to claim 1, wherein holding means for fixing the position of the insert part in the first housing part are formed between the insert part and the first housing part.

3. Vehicle door handle according to claim 1, wherein the insert part is designed partly in a trough-like manner with lateral trough walls and an insert-part trough base connected thereto, wherein the insert-part trough base has at least one recess which, when the insert part and the first housing part are connected, is closed by the first housing part so that the potting trough is formed.

4. Vehicle door handle according to claim 1, wherein the insert part is placed over a cavity in the first housing part and said cavity is closed off by the insert part so as to be inaccessible with respect to the potting agent introduced into the potting trough.

5. Vehicle door handle according to claim 1, wherein the holding means on the insert part are at least partly designed as strips under which the at least one electronic component can be inserted in the insert part so that the electronic component is prevented from floating on a potting agent introduced into the potting trough.

6. Vehicle door handle according to claim 1, wherein the insert part is formed partly with a soft material which is arranged on the insert part in such a way that it seals the transition between the insert part and the first housing part in the base of the formed potting trough.
